(19) United States
(12) Patent Application Publication
(10) Pub. No.: US 2016/0275804 A1
(43) Pub. Date: Sep. 22, 2016

(54) Delivery of Personalized Educational Content

(71) Applicant: eSpark, Inc., Chicago, IL (US)

(72) Inventors: Alexander Koppel, Chicago, IL (US); Luke Shepard, Chicago, IL (US); Gursimran Singh, Chicago, IL (US); Alex Koch, Chicago, IL (US); Thom van der Doef, Chicago, IL (US); Maya Lopuch, San Francisco, CA (US)

(21) Appl. No.: 14/659,252

(22) Filed: Mar. 16, 2015

(51) Int. Cl. G09B 5/12; G09B 5/02; H04L 29/08; G09B 7/00

(52) U.S. Cl. CPC G09B 5/12; G09B 7/00; G09B 5/02; H04L 67/10; H04L 67/306; H04L 67/34

(57) ABSTRACT

Examples provided herein are directed to deploying personalized educational content to student devices. In example implementations, a computing system may communicate with student devices corresponding to students in a classroom setting. The computing system may cause the student devices to obtain educational content from content providers. As a student progresses through a lesson plan by interacting with a student device, the computing system may intelligently deploy educational content that is personalized to the student's academic abilities and needs.

### BACKGROUND

Traditional classroom education generally involves a teacher presenting a single lesson to a whole classroom of students and the students completing the lesson at the same time. Some time later, the students take the same test at the same time to gauge the students' respective comprehension of the lesson. The teacher may spend additional time, perhaps before or after school, with students that struggle, but the whole class moves together to the next unit of study.

Some believe that this traditional model is not the most effective way to meet the varied needs of individual students. Additional teacher-time is often not enough for struggling students and so they tend to fall further behind. On the other hand, students that grasp the material may find their learning experience constrained by a uniform pace of instruction.

The current trend in classroom education is to use technology and digital resources to help improve the students' learning experience. For instance, schools are now providing computers and educational software to enhance the students' learning experience. Such technologies not only help enhance the students' learning experience but also help alleviate the teachers' workload. Nonetheless, improvements to classroom education are still desired.

### BRIEF DESCRIPTION OF THE DRAWINGS

FIG. 1 shows an example network configuration in which certain embodiments may be practiced;

FIG. 2 shows an example computing device;

FIG. 3 shows an example computing system;

FIG. 4 shows a conceptual illustration of an example personalized lesson plan as stored by a computing system;

FIG. 5 shows an example signal-flow diagram;

FIG. 6 shows a flow diagram for an example method;

FIG. 7 shows a flow diagram for another example method; and

FIG. 8 shows a flow diagram for yet another example method.

The drawings are for purposes of example and illustration. It should be understood that the inventions are not limited by the drawings.

### DETAILED DESCRIPTION

### I. Overview

As noted above, the traditional classroom model has room for improvement. Students today have diverse needs, and so a shift toward personalized lesson plans that match a particular student's needs may be beneficial. However, a single teacher often does not have the time to create and schools and schools districts often do not have the resources to facilitate personalized lesson plans for each student. The systems, devices, and methods described herein seek to help with these problems.

According to examples described herein, a computing system in communication with computing devices corresponding to individual students may deploy personalized educational content to each student. Such a system may instruct the computing devices to download and run educational content provided by content providers, such as third-party content providers. As students progress through their respective personalized educational content, the computing system predicts educational content that may help enhance a given student's learning experience and sends that student's computing device instructions to download the predicted content. In this way, each student receives a lesson plan that is designed to the student's academic needs, teachers have more time to interact with students, and schools and/or school districts may intelligently purchase educational content, thereby saving money that may be spent on other resources.

In practice, a network configuration may include a content deployment system (“CDS”) that communicates over a communication network with computing devices that are utilized by students for educational purposes (referred to herein as “student devices”). The CDS may provide a service to a school, school district, or some other educational organization and may include a database of curricula. In practice, teachers, curator services, or the like may design the curricula and provide them to the CDS.

A given curriculum may include learning objectives or learning standards that students in a given grade level are expected to learn over the course of a given school year. Specifically, a given curriculum may include lesson plans for a certain academic subject, such as math or reading, and a given lesson plan may include one or more study units. In general, a given study unit may include certain educational activities that may be performed by a student experiencing various educational content, such as viewing instructive videos or interacting with educational software applications.

In any event, the CDS may store a curriculum by storing identifiers of the educational content that is needed to progress through the lesson plans of that curriculum. For instance, the CDS may store network locators that direct a student device to providers of the particular educational content called for in a lesson plan.

In addition to the curriculum database, the CDS may also store a database of student profiles. Generally, each student profile may include assessment data that indicates a given student's operating grade level for a particular subject. The CDS may use the assessment data and curriculum database to generate a personalized lesson plan for a given student and associate the personalized lesson plan to the student profile. Thereafter, the CDS may update the personalized lesson plan based on the student's progress during the school year.

As discussed above, the CDS may communicate with student devices. A student device may take the form of a laptop, tablet, or smartphone, among other examples. Each student device may include a software application that corresponds to the CDS (referred to herein as a “CDS application”).

At first, each student device may register with the CDS. For instance, when a CDS application is first launched on a student device, the student device and CDS may communicate to register the student device with the CDS. As part of this process, the CDS may assign the student device a unique device identifier. Moreover, the CDS may facilitate registering the student device with content providers, such as Apple's App Store^{SM} and the like. In this way, the student device may be configured to obtain content from these content providers.

Once a student device is registered with the CDS, a student may then use the student device for classroom education. Initially, the student may launch the CDS application and enter a login name that is unique to the student and/or a password. The student device may then send the CDS a lesson plan request that includes student and device information. The CDS may then use such information to identify the student's profile from the student profile database and identify a personalized lesson plan for the student.

Unlike some educational systems, the CDS may utilize one or more third-party content providers to provide the educational content called for in personalized lesson plans. That is, the CDS may instruct student devices to obtain educational content from third-party content providers. As such, an educational organization may purchase a number of licenses that are used to obtain educational content from the third-party content providers. Because the personalized lesson plans may dynamically change based on the performance of the students, among other considerations, a student device may download only a portion of the content for any given personalized lesson plan. The CDS may be configured to forecast educational content that may be needed in the future and purchase licenses for the forecasted content ahead of time. In this way, an educational organization may intelligently purchase licenses based on its projected needs, and content may be available when students need the content.

For instance, once the CDS has identified a personalized lesson plan associated with a given student profile, the CDS may send the student device installation commands for a first portion of the educational content called for by the personalized lesson plan. In turn, the student device may receive these commands and cause the student device to communicate with the content providers that provide the content from the first portion of the lesson plan.

The student device may then download educational content from the content providers, and the student may then begin his or her personalized lesson plan. As the student progresses through a given study unit, the CDS application may cause the student device to transmit progress data to the CDS. Such data may indicate the study unit of the lesson plan that the student is currently working on, the pace at which the student is progressing through the lesson plan, and/or a performance indictor that reflects the student's comprehension of the lesson plan, among other information.

At some point in time, the CDS may determine that the student's progression through the lesson plan has reached a certain threshold point and that additional educational content may be needed in the future. Accordingly, the CDS may send the student device installation commands for a second portion of the educational content called for by the personalized lesson plan. Similar to the first received installation commands, the student device may then communicate with the content providers to obtain the required educational content.

Moreover, the CDS may also send the student device removal commands for some or all of the educational content previously installed by the student device. In this way, the licenses that were used to obtain the previously installed content may be used by the student device to obtain new content or perhaps may allow another student device to obtain a copy of the previously installed content.

While the above was described with respect to a single student device, in practice, the CDS may consider data from multiple student devices and predict the needs of multiple students, perhaps even a whole school district or other educational organization. In particular, the CDS may predict what content should be purchased and deployed to student devices based on aggregating student progress data from all students in a classroom, a school, a school district, or any combination thereof. For instance, the CDS may be configured to perform one or more forecasting operations to determine the content that is needed by individual students and hence for entire classrooms, schools, and districts. In this way, the CDS intelligently purchases content licenses, which may help schools and districts save money (e.g., by bulk purchase discounts), and instructs student devices to download content prior to the time that the students need the content.

As indicated above, examples provided herein are directed to deploying personalized educational content to student devices. In one aspect, a computing system is provided. The computing system comprises a network interface, at least one processor, a non-transitory computer-readable medium, and program instructions stored thereon. The program instructions are executable by the at least one processor to cause the computing system to: (1) transmit to a computing device an indication of a first portion of a lesson plan, wherein the lesson plan comprises a plurality of educational content, (2) receive from the computing device via the network interface activity data comprising progress data indicating a progression through the first portion of the lesson plan, (3) based at least on the progress data, determine that the progression through the first portion of the lesson plan exceeds a progress threshold, and (4) based at least on determining that the progression exceeds the progress threshold, transmit to the computing device an indication of a second portion of the lesson plan.

In another aspect, a computing device is provided. The computing device comprises a network interface, at least one processor, a non-transitory computer-readable medium, and program instructions stored thereon. The program instructions are executable by the at least one processor to cause the computing device to: (1) receive from a computing system via the network interface an indication of a first portion of a lesson plan, wherein the indication of the first portion of the lesson plan comprises a plurality of identifiers of respective educational content, (2) based on the received indication of the first portion of the lesson plan, transmit to one or more third-party content providers a request for educational content, wherein the request for educational content comprises at least one identifier from the plurality of identifiers, and (3) receive from the one or more third-party content providers educational content identified by the at least one identifier.

In yet another aspect, a method is provided. The method involves a computing system: (1) assigning a lesson plan to a student profile, wherein the lesson plan comprises a plurality of educational content, (2) transmitting to a computing device corresponding to the student profile an indication of a first portion of a lesson plan, wherein the indication of the first portion of the lesson plan comprises at least one installation command indicating a command for the computing device to install educational content from a third-party content provider, (3) receiving from the computing device activity data comprising progress data indicating a progression through the first portion of the lesson plan, (4) based at least on the progress data, determining that the progression through the first portion of the lesson plan exceeds a progress threshold, and (5) based at least on determining that the progression exceeds the progress threshold, transmitting to the computing device an indication of a second portion of the lesson plan.

In another aspect, a computing system is provided. The computing system comprises a network interface, at least one processor, a non-transitory computer-readable medium, and program instructions stored thereon. The program instructions are executable by the at least one processor to cause the computing system to: (1) determine an expected number of content licenses projected to be used within a first predetermined duration of time; (2) transmit to a plurality of computing devices via the network interface a plurality of installation commands, wherein a given installation command indicates a command for a given computing device to utilize a given content license to obtain educational content from a given third-party content provider; (3) receive from the plurality of computing devices a plurality of progress data, wherein each progress data indicates a progression through a given lesson plan; (4) based at least on the received progress data, determine an expected number of content licenses projected to be used within a second predetermined duration of time; and (5) transmit to the plurality of computing devices via the network interface a second plurality of installation commands.

In reading this specification, one of ordinary skill in the art will understand that this disclosure includes numerous other embodiments, such as systems configured to perform, methods that involve, and computer-readable media comprising instructions to execute some of the above-mentioned operations as well as additional operations discussed below.

### II. Example Network Configuration

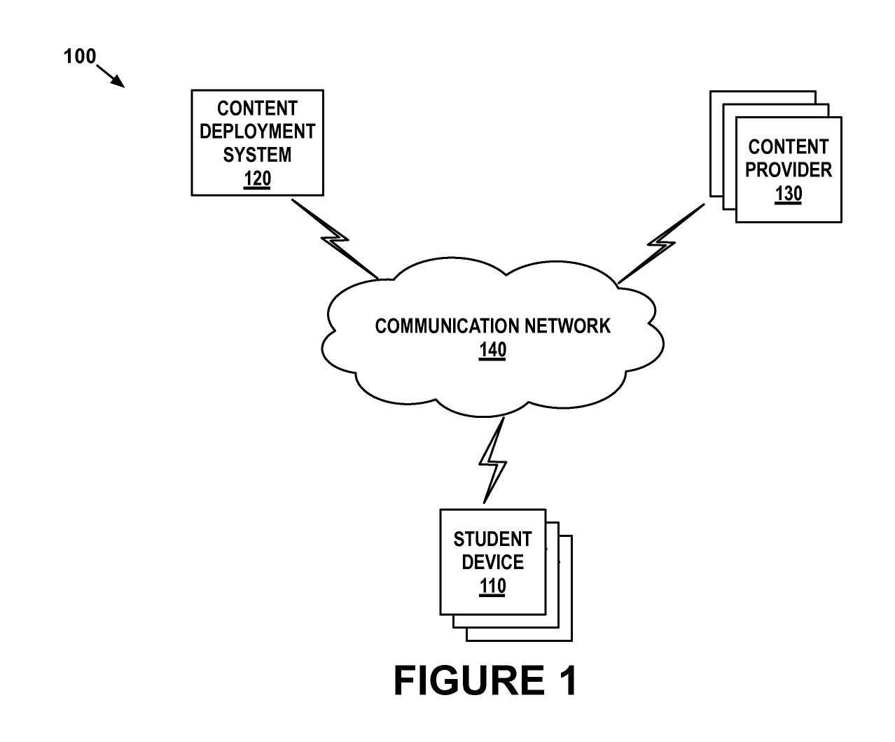

FIG. 1 shows an example network configuration 100 in which one or more embodiments disclosed herein may be practiced or implemented. As shown, the network configuration 100 may include one or more student devices 110, a content deployment system (“CDS”) 120, and one or more content providers 130. A communication network 140 may communicatively couple these network components. The network configuration 100 may include more or less of the illustrated network components and/or additional network components not illustrated.

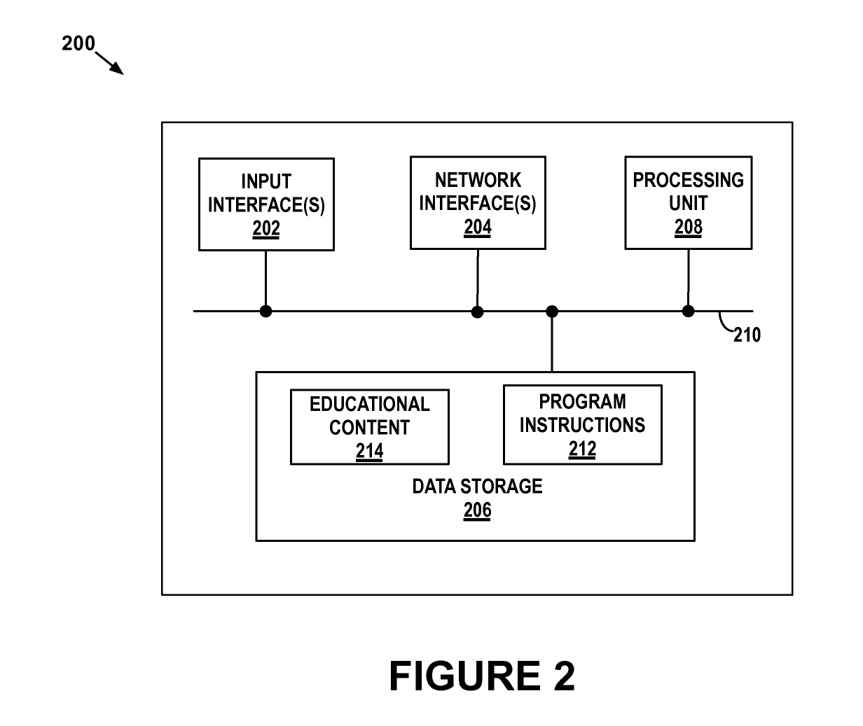

In general, a student device 110 may take the form of a computing device configured to transmit and receive data via the communication network 140. Such a computing device may be configured to download, install, store, and run software applications. Example student devices include laptops, desktops, tablets, smartphones, wearable computing devices, and smart TVs, among other examples. The student devices 110 are discussed in further detail below in connection with FIG. 2.

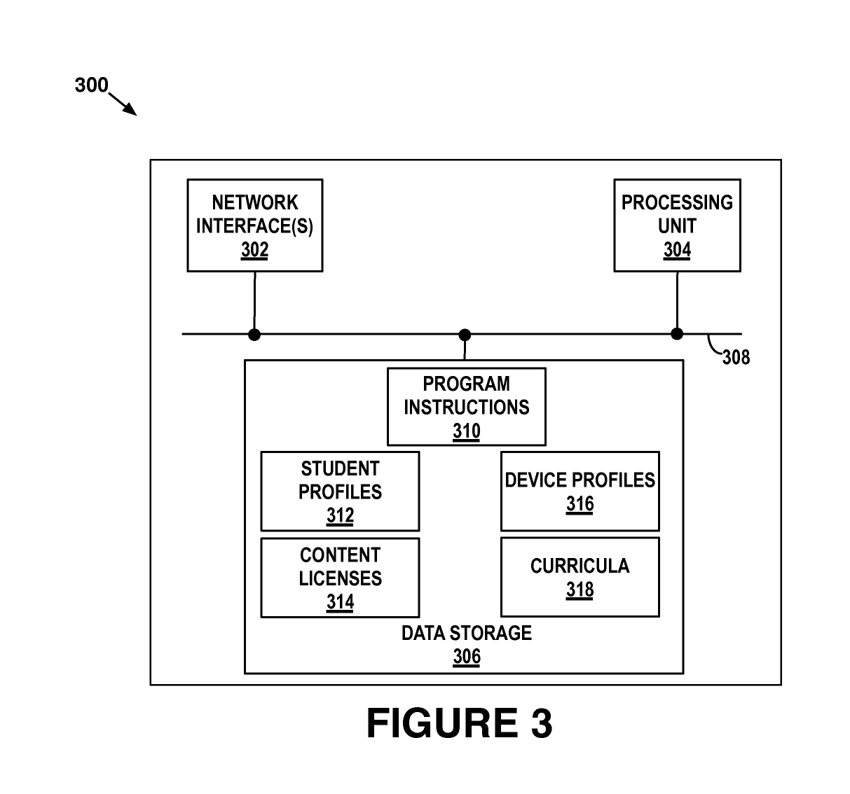

Broadly speaking, the CDS 120 may take the form of a computing system that is configured to manage the student devices 110. Specifically, the CDS 120 may be or may include a device management system, such as a mobile device management (“MDM”) system, which is configured to facilitate adding and removing educational content to and from student devices. In practice, the CDS 120 may be specific to a school district, segment of schools within a school district, or school, among other examples. In particular, the CDS 120 may correspond to a service that an educational organization subscribes to. In some examples, the CDS 120 may service multiple school districts. The CDS 120 is discussed in further detail below in connection with FIG. 3.

Generally, a content provider 130 is configured to provide content, such as educational content, to computing devices, such as the student devices 110. In examples, the content providers 130 may be third-party content providers that are independent from the CDS 120. That is, the CDS 120 and the content providers 130 may be owned and operated by different entities.

In examples, a content provider 130 may include one or more computing systems, such as servers or the like, that operate together or independently to perform one or more operations disclosed herein. Such a computing system may include a network interface, a processing unit, and data storage, all of which may be communicatively linked together. The network interface may facilitate communications between the content provider 130 and other network components on the communication network 140. The processing unit may include one or more processors, such as general-purpose and/or special-purpose processors. The data storage may include a non-transitory computer-readable medium, such as optical, magnetic, or flash memory, and may include program instructions that are executable by the processing unit to perform various operations described herein.

Each content provider 130 may be associated with a unique network location, which may be identified by a uniform resource identifier (“URI”), a uniform resource locator (“URL”), an IP address, or the like. A content provider 130 may maintain a database of downloadable content, such as videos, music, podcasts, audio books, other multimedia, and/or software applications, among other examples. Computing devices may communicate with the content provider 130 to obtain content from the provider. In some examples, once a computing device downloads and installs a content provider's software application, the computing device may utilize the application to access other content from the provider.

In practice, some content providers 130 may require registration prior to providing content to computing devices. These content providers 130 may then store account credentials, such as login names and/or passwords, for computing devices that are associated with a registered content account. This type of content provider 130 may be configured to match login credentials with a registered account before providing content to a computing device. In examples, a school district or school may register a district- or school-wide content account with one or more content providers 130. Other accounts, such as student content accounts, may be linked to the district- or school-wide content account to facilitate obtaining content from the content providers.

In some examples, one or more of the content providers 130 may be configured to store and provide software applications and/or other content that correspond to other content providers 130. An example of such a content provider 130 is Apple's App Store^{SM}. In practice, this type of content provider may require a license from or assigned to a computing device before providing content, such as a software application, to the computing device.

As noted above, the communication network 140 communicatively couples the various network components of the network configuration 100. The communication network 140 may be or may include one or more wide-area networks (“WANs”) and/or local-area networks (“LANs”). Further, the communication network 140 may include wired and/or wireless infrastructure and may operate according to one or more network protocols. In example implementations, the communication network 140 may include the Internet and/or one or more cellular networks, among other networks.

As also noted above, the network configuration 100 may include additional components not illustrated. For example, the student devices 110 may communicate with the communication network 140 via network infrastructure, such as an access point or the like. In a specific example, a school building may be configured with a Wifi network that is linked to the communication network 140 via a router or the like, and the student devices 110 may wirelessly access the communication network 140 via the Wifi network.

### III. Example Student Device

FIG. 2 shows a simplified block diagram of an example computing device 200. The computing device 200 may be the student device 110 from FIG. 1. As shown, the student device 200 may include one or more input interfaces 202, one or more network interfaces 204, data storage 206, a processing unit 208, and one or more communication links 210 that couple together some or all of the components of the student device 200. It should be understood that student device 200 may include more or less of the illustrated components as well as other components not shown. For instance, the student device 200 may include a battery, one or more sensors, a graphics processing unit, and/or one or more output components, among other components.

The one or more input interfaces 202 may generally be configured to facilitate user interaction with the student device 200. In examples, the one or more input interfaces 202 may include or provide connectivity to input components, such as a touch-sensitive screen or pad, a button, a wheel, a keyboard or keypad, a microphone, etc. Additionally, the one or more input interfaces 202 may include or provide connectivity to output components, such as a graphical display, a speaker, a headphone jack, etc. In some cases, input and/or output components may be separate from (e.g., located external to) the student device 200. Other configurations are possible as well.

The one or more network interfaces 204 may be configured to facilitate receiving and transmitting signals over one or more communication networks. The one or more network interfaces 204 may provide for wireless and/or wired communication. As such, a network interface 204 may include an antenna structure and/or a port configured to transmit and/or receive various signals and perform various operations disclosed herein. Other configurations are also possible.

The data storage 206 may include a non-transitory computer-readable medium, such as optical, magnetic, or flash memory. As shown, the data storage 206 may include program instructions 212, which may be executable by the processing unit 208 to carry out various operations described herein. Also illustrated, the data storage 206 may include educational content 214 that may have been downloaded from the one or more content providers 130. The educational content 214 may take the form of multimedia files or executable software applications, among other examples. For instance, the educational content 214 may include a CDS application that is operable to automatically perform various operations without user intervention, such as assembling lesson plans, and/or communicating with the CDS 120 and/or content providers 130, among other examples. Additionally, the data storage 206 may include license data indicating content licenses that may be used to obtain educational content from the content providers 130.

The processing unit 208 may include one or more general-purpose processors (e.g., microprocessors) and/or one or more special-purpose processors (e.g., application specific integrated circuits) and may be integrated in whole or in part with some or all of the other components of the student device 200. The processing unit 208 may be configured to download, store, and access the educational content 214. Moreover, the processing unit 208 may be configured to store, access, and execute the program instructions 212 that are stored in the data storage 206 to perform the operations of a student device described herein.

The one or more communication links 210 may provide wired or wireless connections between the various components of the student device 200. In particular, a communication link may be a wired serial bus, such as a universal serial bus or a parallel bus, or a wireless connection, among other examples.

### IV. Example Content Deployment System

FIG. 3 shows a simplified block diagram of an example computing system 300. In examples, some components illustrated in FIG. 3 and/or some operations discussed below may be distributed across or performed by multiple computing systems. However, for sake of example, the components and operations are described as part of and performed by one example computing system 300.

The computing system 300 may be the CDS 120 from FIG. 1. As shown, the CDS 300 may include one or more network interfaces 302, a processing unit 304, data storage 306, and one or more communication links 308 that couple together all of the components of the CDS 300. These components may be similar to those discussed above in connection with FIG. 2. However, in addition to program instructions 310, the data storage 306 may also include a student profile database 312, a content license database 314, a device profile database 316, and a curriculum database 318, among other data. Some of this data may be provided to the CDS 120 via another computing system or device, such as one operated by a teacher, school administrator, education-related service provider, or content provider, among other examples.

The student profile database 312 may include student profiles for each student enrolled at a school that is part of a particular school district or educational organization. In examples, the CDS 120 may generate student profiles based on student rosters uploaded to the CDS 120. In other examples, the CDS 120 may receive student profile data from a computing device or system. For instance, a student, teacher, or administrator may manually create a student profile and upload the student profile to the CDS 120 via a computing device. Additionally or alternatively, a third-party computing system may transmit student profiles to the CDS 120. Other examples are also possible.

In examples, the student profiles may be organized and stored in a number of different manners. For instance, the student profiles may be organized and stored by school, by grade level, by classroom, or by some combination thereof.

A given student profile may be assigned to a particular student. The student profile may include background information, a student identifier, a student content account, assessment data, and one or more personalized lesson plans, among other student information.

The background information may include schools the particular student previously attended, the school the student is currently attending, the names of teachers that previously taught the particular student, the student's current teacher, and the student's current enrollment grade level, among other information.

The student identifier may be operable to uniquely identify the student assigned to the given student profile. In examples, the student identifier may take the form of a numeric, alphabetic, or alphanumeric identifier. In one particular example, the student identifier may take the form of the particular student's first and last name. Other examples are also possible.

The student content account may be operable to obtain content from content providers 130. The student content account may be linked to a district- or school-wide content account that provides access to one or more content providers 130. In practice, the CDS 300 may be configured to assign purchased content licenses from a given the district- or school-wide content account to student content accounts. In examples, this operation may involve the CDS 300 communicating with another computing system, such as a content provider 130 or a third-party license management service, to identify particular licenses that are assigned to a given student account.

The assessment data generally indicates the particular student's operating grade level for a particular subject. As used herein, “operating grade level” reflects a student's abilities within and comprehension of a particular academic subject. A student's “operating grade level” may be different from the student's enrollment grade level. For instance, a student that is currently in the third grade may have a fifth grade operating grade level in math and a second grade operating grade level in reading.

The assessment data may derive from a number of sources. For example, the assessment data may derive in whole or in part from a standardized test completed by the particular student before or during a given school year. Additionally or alternatively, the assessment data may derive from a teacher's assessment of the particular student's abilities. For instance, if the particular student joined the school district after the standardized test was offered, then the student's teacher may assess the student's abilities, for example, based on the student's age, and manually provide assessment data to the CDS 300 via a computing device. In other examples, the assessment data may additionally or alternatively derive from the CDS 300 or some other system determining assessment data based on progress data previously provided by a student device being used by a given student. The assessment data may be derived in other manners as well.

Moreover, the assessment data may be dynamically updated, perhaps periodically, as the particular student progresses through personalized lesson plans, completes classroom tests or quizzes, and/or improves or regresses on standardized tests. The student's results from such activities may be provided to the CDS 300 via a teacher's computing device or a classroom management system, among other examples.

In any event, the CDS 300 may use at least the assessment data and the curriculum database 318 to determine personalized lesson plans for the particular student. An indication of these lesson plans may be stored or mapped to the student profile for later use by the particular student via a student device. Alternatively, a teacher, administrator, or curator service may generate the personalized lesson plans and transmit them to the CDS 300 via a computing device or system.

The content license database 314 may include content-license information corresponding to a given school district or school. Such information may include a district- or school-wide content account from which the district or school purchases content licenses and/or other content accounts that are linked to that account, such as student content accounts. Moreover, the content-license information may include the purchased content licenses or a representation of the purchased content licenses. In any event, the CDS 300 may be configured to utilize content-license information to assign purchased license accounts to student devices or student content accounts to facilitate obtaining educational content.

In some examples, the school district may purchase licenses that are applicable to a number of different content providers, and in that scenario, the content license database 314 may organize and store the content licenses in any appropriate manner. In other examples, the school district may purchase sets of licenses that are applicable to respective individual content providers. For instance, the school district may purchase thirty licenses for a first software application, fifty licenses for a second software application, and a hundred licenses for instruction videos. In this context, the content license database 314 may organize and store the content licenses based on the corresponding content provider, among other examples.

In any event, the content license database 314 may provide an assignment indicator for each content license that indicates whether the content license is currently assigned to a student device. In the event that the assignment indicator indicates that a given content license has been assigned, the content license database 314 may also include an indicator of the student device to which the content license was assigned. In some examples, the content license database 314 may also include a temporal indicator that indicates when the content license was assigned.

The device profile database 316 may include device profiles for each student device that is registered with the CDS 300. In examples, registration may involve a student device downloading and installing a CDS application. As such, the device profiles may indicate each student device with an installed CDS application.

A given device profile may be assigned to a particular student device. The device profile may include a device identifier, an indication of licenses assigned to the particular device that are available for use, and/or a record of the educational content currently stored on the particular student device. Similar to the student identifier, the device identifier may be operable to uniquely identify the particular student device. The device identifier may take the form of a numeric, alphabetic, or alphanumeric identifier and may be generated by the CDS 300.

In practice, the CDS 300 may be configured to generate a device profile when a student device first registers with the CDS 300. The CDS 300 may also be configured to maintain and update the device profile as students utilize the student device to complete lesson plans.

The curriculum database 318 may include various curricula. In practice, the curricula may be created by teachers, third-party curators, or the like and may be uploaded to the CDS 300 via a computing device or some other computing system. In some examples, the CDS 300 may create (e.g., based on one or more algorithms) or facilitate in the creation of curricula, and/or the CDS 300 may modify curricula throughout a school year based on a number of considerations.

Broadly speaking, a given curriculum may include a set of lesson plans that are tailored to meet certain learning objectives or learning standards that a student is expected to learn upon completing the set of lesson plans. A given curriculum may be specific to a particular academic subject, such as math or reading.

A given lesson plan may include one or more study units that target a particular area in a given academic subject. A given study unit may utilize various educational content, such as instructive videos and educational software applications, among other examples. Each study unit may involve certain educational activities that may be performed by a student interacting with a software application on a student device.

A lesson plan may include a number of study units that a student is expected to complete, each of which may vary in difficulty. As such, a lesson plan may include sequence information that identifies study units or activities that should be performed after a current activity is completed. In examples, the CDS 300 may dynamically modify a lesson plan as a student progresses through study units based on the student's pace through and/or comprehension of the lesson plan, among other considerations.

The curricula may be organized and stored in a number of manners. For instance, the curricula may be organized and/or stored by academic subject, by operating grade level, by school, and/or by classroom, among other examples. In examples, the CDS 300 may store in the curricula database 300 standardized and personalized lesson plans for a given curriculum. The standardized lesson plans might serve as a template or guide for the CDS 300 to generate personalized lesson plans based on a particular student's academic abilities and/or needs. The CDS 300 may store a curriculum by storing identifiers of the educational content that are needed to progress through the lesson plans of the curriculum. For instance, the CDS 300 may store network locators, such as URI or URLs, that direct a student device to content providers of the particular educational content called for in a lesson plan.

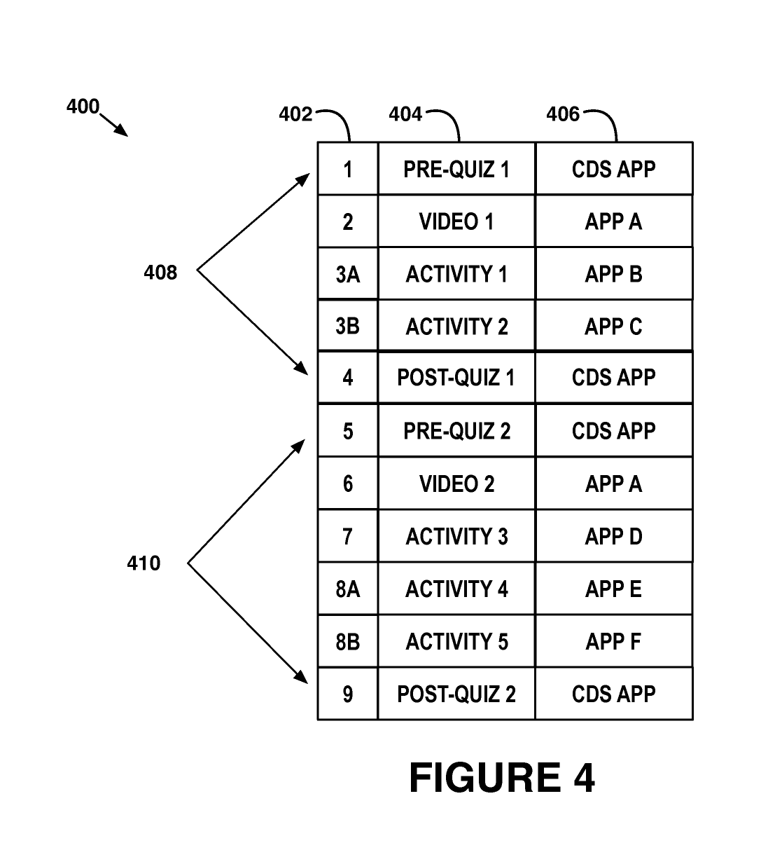

FIG. 4 shows a conceptual illustration of an example personalized lesson plan 400 as stored in the curriculum database 318. As shown, the personalized lesson plan 400 is stored in a tabular manner. In particular, the table includes a sequence column 402, an activity column 404, and an application-required column 406. In this particular example, the personalized lesson plan 400 includes study unit 408 and study unit 410.

The sequence column 402 indicates the order in which a student might progress through the personalized lesson plan 400 by completing the corresponding activity shown in the activity column 404. For instance, the student would start the lesson plan (e.g., sequence number 1) by completing Pre-Quiz 1, then (e.g., sequence number 2) watch Video 1, follow that by completing either or both Activities 1 and 2 (e.g., the letter in sequence numbers 3A and 3B indicate that the student may choose how he or she progresses through this portion of the personalized lesson plan 400), and so forth.

In certain activities, the student might be required to exhibit a certain degree of comprehension before proceeding to a subsequent activity. That is, a threshold percentage or number of correct answers or a threshold grade might be required before moving on to another activity. For example, Post-Quiz 1 might include five multiple-choice problems, and a student may only progress from study unit 408 to study unit 410 if the student answers four of the five questions correctly. In the event that the student does not meet this threshold, the lesson plan might direct the student back to Video 1, Activity 1 and/or Activity 2, perhaps for a predetermined amount of time, before allowing the student to attempt Post-Quiz 1 again.

The activity column 404 indicates particular activities that a student will attempt to complete at a given spot within the personalized lesson plan 400. In practice, activity instructions may be stored within each entry of activity column 404, such as “Complete Pre-Quiz 1”, “Watch Video 1”, and “Select Activity 1 or 2”, among other example instructions.

The application-required column 406 indicates the educational software application that is needed for the student to perform the corresponding activity in the activity column 404. For example, the student would use the CDS application stored on the student device to complete Post-Quiz 2 and would need software Application F to complete Activity 5.

One of ordinary skill in the art will appreciate that FIG. 4 depicts one example manner in which the CDS 300 might store an example lesson plan and that numerous other manners of storing lesson plans are possible. Moreover, one ordinary skill in the art will appreciate that the personalized lesson plan 400 is but one example of a personalized lesson plan and that numerous other example lesson plans are certainly possible and contemplated herein.

In examples, the CDS 300 may be configured to aggregate student progress data over a predetermined amount of time and identify educational content that may help improve students' comprehension of the subject matter. In this manner, the CDS 300 may be configured to identify content that might be beneficial to use in future curricula and perhaps generate future curricula.

### V. Example Deployment Operations

As discussed above, examples provided herein are directed to providing personalized educational content to student devices. Operations may be discussed herein with respect to a particular system or device. This however is for purposes of example and explanation only and should not be construed as limiting. Other systems and/or devices may perform all or part of the operations without departing from the scope of the present examples.

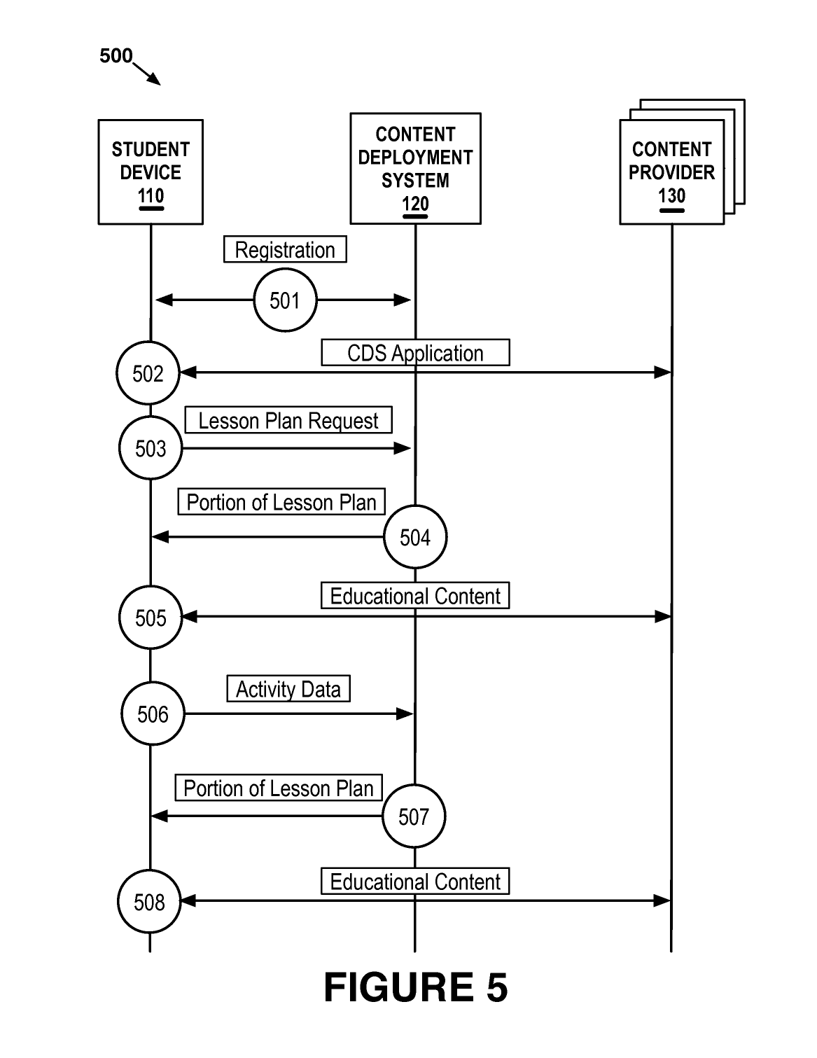

FIG. 5 shows an example signal-flow diagram 500 depicting signal flow between a student device 110, the CDS 120, and/or one or more content providers 130, in accordance with example implementations. For clarity, FIG. 5 is described herein with reference to an exemplary teacher (Mr. Donlan) and an exemplary student (Annie). However, it should be understood that this is for the purposes of example and explanation only and should not be construed as limiting.

As suggested above, the student device 110 and the CDS 120 may be configured to exchange signals 501 to facilitate registering the student device 110 with the CDS 120. In some examples, the student device 110 may utilize a CDS application previously installed on the student device 110 to facilitate registering with the CDS 120. In other examples, the student device 110 may utilize a web-browser to facilitate registering with the CDS 120, and then the student device 110 may download the CDS application during or as a result of the registration process. Accordingly, the student device 110 may download 502 the CDS application from a content provider 130 before, after, or during the registration process. In some examples, the student device 110 may instead download the CDS application from the CDS 120.

In any event, the student device 110 registering with the CDS 120 may involve the student device 110 transmitting a registration request to the CDS 120. The registration request may include device information, such as an indication of the student device's network location, an indication of the school district that owns the student device 110, and/or the serial number of the student device 110, among other information.

Based on receiving the registration request, the CDS 120 may be configured to perform a number of operations. For instance, the CDS 120 may be configured to generate a device profile and assign the device profile to the student device 110. The CDS 120 may also be configured to generate a device identifier that is stored in the device profile. The generated device identifier may allow the CDS 120 to identify the student device 110 from all other student devices that register with the CDS 120. The CDS 120 may be configured to transmit an indication of the device identifier to the student device 110 for use in future communications between the CDS 120 and the student device 110.

Moreover, the CDS 120 may be configured to associate the student device 110 to a district- or school-wide content account, such as a school-owned iTunes® account or other type of volume purchase program (“VPP”) account. In particular, during the registration process, the student device 110 may be linked to a student content account, such as a student's iTunes® account, which is itself linked to the school content account. Thereafter, the CDS 120 may be configured to assign one or more content licenses to the student device 110 (or student content account), which may involve the CDS 120 transmitting to a computing system (e.g., a content provider 130) assignment information that indicates particular licenses that are assigned to a given student device (or student account). This process may allow the student device to access educational content from the content providers 130.

Some time after registration, perhaps at the start of a school year, a teacher (Mr. Donlan) may provide the student device 110 to one of his students (Annie) Previously, Mr. Donlan's classroom roster was uploaded to the CDS 120, and the CDS 120 generated and stored a student profile for Annie that includes a student identifier unique to Annie Mr. Donlan may provide Annie with her login information (e.g., Annie's student identifier), and Annie may provide one or more user inputs at the student device 110 to launch the CDS application and login using Annie's student identifier.

The student device 110 may be configured to receive input data indicating a request to launch the CDS application and Annie's student identifier. After the CDS application is launched, the student device 110 may be configured to transmit 503 a lesson plan request to the CDS 120. The lesson plan request may include Annie's student identifier and the device identifier previously stored by the student device 110, among other information.

The CDS 120 may be configured to receive the lesson plan request and identify Annie's student profile. Previously, the CDS 120 may have assigned the personalized lesson plan 400 from FIG. 4 to Annie's student profile (e.g., based on Annie's assessment data, among other considerations). Based on the received lesson plan request, the CDS 120 may be configured to determine that Annie's student profile includes the personalized lesson plan 400.

The CDS 120 may be configured to determine a first portion of the personalized lesson plan 400 that should be provided to the student device 110. In some examples, the CDS 120 may be configured to perform this operation based on a predetermined number of educational content or a predetermined number of study units as the first portion of the lesson plan. Additionally or alternatively, the CDS 120 may be configured to determine the first portion of the lesson plan that should be provided to the student device 110 based on considerations such as the difficulty of the educational content and/or an average pace of completion. In some cases, the average pace of completion may indicate Annie's average pace of completion of previously completed educational content, the average pace of completion of the educational content by other students with an operating grade level similar to Annie's, the average pace of completion by all students that have completed the educational content, or any combination thereof. Other considerations may involve network performance of the communication network 140 (e.g., the amount of content may vary based on network connections) and the number of content licenses available for use and the number of student devices in a given classroom, school, or school district, among other considerations.

Thereafter, the CDS 120 may be configured to determine the educational content that is required by the student device 110 to allow Annie to work through the first portion of the lesson plan. In practice, this determination may involve considering the educational content currently stored on the student device 110. For example, the CDS 120 may be configured to use the received device identifier to identify the student device's 110 device profile from which the CDS 120 may determine what content is already stored on the student device 110. Continuing off the above example, the CDS 120 may determine that the student device 110 needs Applications A, B, and C.

Then, the CDS 120 may be configured to transmit 504 an indication of a first portion of the personalized lesson plan 400 to the student device 110. Generally, the indication of the first portion of the personalized lesson plan 400 may include any information required by the CDS application to assemble the first portion of the personalized lesson plan. An example of this indication may include sequence information associated with activities from study unit 408, activity instructions for the activities in study unit 408, and one or more installation commands for Applications A, B, and C.

In practice, the CDS 120 may be configured to transmit to the student device 110 a plurality of installation commands, where each installation command indicates a command for the student device 110 to install a given educational content from a given third-party content provider. Alternatively, the CDS 120 may be configured to convey the same commands but in a single installation command. In any event, for example, the one or more installation commands may include respective content indicators of Applications A, B, and C, examples of which may include application identifiers (e.g., App Store^{SM} identifiers) or network locators.

In another example, the indication of the first portion of the personalized lesson plan 400 may instead include sequence information and/or activity instructions for the whole personalized lesson plan 400 (e.g., for both study unit 408 and study unit 410) but may only provide installation commands for the educational content called for by the first portion of the personalized lesson plan (e.g., Applications A, B, and C in the current example). In yet another example, the indication of the first portion of the personalized lesson plan 400 may only include installation commands for the educational content. In such examples, the CDS 120 may be configured to provide sequence information and/or activity instructions at a later time, such as when Annie provides an input at the student device 110 indicating a command to begin her personalized lesson plan. Other examples are also possible.

The student device 110 may be configured to receive the indication of the first portion of the personalized lesson plan 400 and then automatically use the CDS application to assemble the first portion of the lesson plan. That is, the student device 110 may assemble the first portion of the lesson plan without any user intervention. Generally, assembling the first portion of the lesson plan may involve the CDS application generating a sequence of activity instructions that guide Annie through her personalized lesson plan.

Based on the received indication of the first portion of the personalized lesson plan 400, the student device 110 may be configured to transmit to one or more of the content providers 130 one or more requests for educational content. In some cases, this operation may involve the student device 110 transmitting to one content provider one or multiple requests for one or more educational content that the content provider obtains from another content provider. For example, in a setting that includes a content provider similar to Apple's App Store^{SM}, the student device 110 may transmit a single request with identifiers of Applications A, B, and C (or three separate requests) to that content provider that may then facilitate obtaining Applications A, B, and C.

In other cases, the student device 110 transmitting the one or more requests for the educational content may involve the student device 110 transmitting individual requests to particular content providers. For instance, the student device 110 may be configured to transmit to a first content provider a request for Application A that includes an identifier of Application A, transmit to a second content provider a request for Application B that includes an identifier of Application B, and transmit to a third content provider a request for Application C that includes an identifier of Application C.

In any event, the student device 110 may be configured to then download 505 educational content (e.g., Applications A, B, and C) from one or more of the content providers 130. In practice, this operation may involve the student device 110 receiving educational content from one content provider or multiple content providers. In some cases where the student device 110 transmits to one content provider a request for educational content, the student device 110 may receive educational content from one or more other content providers. Other examples are also possible.

Before, during, or after the student device 110 downloads some or all of Applications A, B, and C, Annie may begin progressing through the personalized lesson plan 400. She may begin with the Pre-Quiz 1 and progress through the sequence of activities to the Post-Quiz 1. Accordingly, the student device 110 may be configured to receive input data indicating Annie's progression through the received Applications A, B, and/or C. As Annie utilizes the student device 110 to complete the activities in study unit 408, the student device 110 may be configured to transmit 506 to the CDS 120 activity data that includes progress data and the device identifier.

Broadly speaking, the progress data indicates Annie's progression through the personalized lesson plan 400. In examples, the progress data may indicate the study unit and/or activity that Annie is currently working on, study units and/or activities that Annie has already completed, the pace (e.g., time duration) at which Annie is progressing through the study unit, the pace at which Annie has completed individual activities or prior study units, and/or a performance indictor that reflects the Annie's comprehension of the lesson plan (e.g., scores on activities Annie has already completed), among other information.

In practice, the student device 110 may be configured to transmit activity data to the CDS 120 based on a number of triggers. In one example, the student device 110 may be configured to transmit activity data each time the student device 110 determines that Annie has completed an activity, such as after Annie completes the Pre-Quiz 1, finishes watching Video 1, and so forth. In another example, the student device 110 may be configured to transmit activity data periodically, such as after a predetermined amount of time.

In yet another example, a trigger to transmit activity data may be an indicator that a limited amount of educational content remains that has yet to be completed. That is, the trigger may indicate that Annie only has a limited number of remaining activities to complete. In such examples, the student device 110 may be configured to transmit activity data after determining that Annie's progression through the lesson plan exceeds a progress threshold. For instance, the progress threshold may be a position within the lesson plan, such as a “buffer zone.” In particular, the position may indicate that the number of remaining study units, activities, or problems is below a particular value or that an expected amount of time before Annie completes the current portion of the lesson plan is below a particular duration.

In other examples, a trigger to transmit activity data may be an indicator of Annie's comprehension of the lesson plan. For instance, the student device 110 may be configured to transmit activity data after inferring that Annie understands the material and needs to be further challenged. In particular, the student device 110 may determine that Annie's progression through the lesson plan exceeds a first progress threshold, such as an expected pace of progression by Annie through the first portion of the lesson plan or a particular score value (e.g., percentage or number of correct answers on Pre-Quiz 1, Activity 1, and/or Activity 2). On the other hand, the student device 110 may also be configured to transmit activity data after inferring that Annie is struggling with the material. In particular, the student device 110 may determine that Annie's progression through the lesson plan is below a second progress threshold based on Annie's pace, scores, and/or other performance indicators. Other examples are also possible.

In practice, any of the progress thresholds described herein may be determined based on a student's personalized lesson plan. As such, some students may have different progress thresholds than other students. Moreover, a given progress threshold may be predetermined or dynamically determined by the CDS 120. For example, a predetermined progress threshold may be part of a lesson plan that is provided to or otherwise accessed by the CDS 120. Alternatively, a dynamic progress threshold may be dynamically determined by the CDS 120 based on a number of considerations, such as a student's progress data and/or assessment data, among other examples. In particular, the CDS 120 may be configured to utilize one or more algorithms to generate a given dynamic progress threshold. Other examples are also possible. In some cases, a given lesson plan may include both dynamic and predetermined progress thresholds.

In some implementations, instead of the student device 110 transmitting activity data to the CDS 120, the student device 110 may be configured to transmit 506 to the CDS 120 a request for an additional portion of the personalized lesson plan 400 (e.g., an additional study unit), additional educational content from the personalized lesson plan 400 (e.g., in a scenario where the student device 110 already received the whole set of sequence information and activity instructions) or an updated lesson plan (e.g., in a scenario where the student device 110 infers that the current lesson plan is too difficult or too easy). For instance, in some examples, the student device 110 may be configured to transmit such a request after determining that Annie's progression through the lesson plan exceeds or is below a progress threshold, as just discussed.

In any event, the CDS 120 may be configured to receive from the student device 110 activity data that includes the progress data and device identifier. Based on the received activity data, the CDS 120 may be configured to determine whether the student device 110 requires additional or different educational content or perhaps a new lesson plan altogether. In examples, this determination may involve the CDS 120 determining that the student device 110 has a limited amount of educational content that remains to be completed, that Annie understands the material and needs to be further challenged, and/or that Annie is struggling with the material, which may be determined similar in some respects to the above discussion. For instance, the CDS 120 may be configured to determine whether Annie's progression through the lesson plan exceeds or is below any of the above-discussed progress thresholds.

In the event that the CDS 120 determines that Annie's progression through the first portion of the personalized lesson plan (e.g., study unit 408) indicates that new or additional educational content is currently needed or will be needed in the future (e.g., based on a determination that the progression exceeds or is perhaps below a predetermined threshold), the CDS 120 may be configured to then determine a second portion of the personalized lesson plan 400 that should be provided to the student device 110. Alternatively, the CDS 120 may make this determination based on receiving from the student device 110 a request for an additional portion of the personalized lesson plan. That is, in some examples, the student device 110 may itself instruct the CDS 120 that an additional portion of the lesson plan is needed.

Additionally or alternatively, the CDS 120 may be configured to determine a second portion of the personalized lesson plan 400 that should be provided to the student device 110 based on a number of other considerations. That is, the CDS 120 may be configured to determine the second portion of the personalized lesson plan based on considerations other than Annie's progress through the first portion of the lesson plan. In this way, the CDS 120 may determine and then provide to the student device 110 instructions regarding the second portion of the lesson plan before Annie needs additional content, perhaps even before Annie starts the first portion of the lesson plan.

For example, the CDS 120 may be configured to perform this operation based on an installation state of the student device 110. That is, the CDS 120 may determine the second portion of the personalized lesson plan 400 after determining that the student device 110 has installed all or some threshold portion of the educational content called for by the first portion of the personalized lesson plan 400. The CDS 120 may make such a determination based on installation data that it receives from the student device 110 that the student device 110 transmits to indicate educational content it has installed.

In another example, the CDS 120 may be configured to determine the second portion of the lesson plan based on whether the student device 110 has received from the CDS 120 all or some threshold portion of the installation commands corresponding to the first portion of the lesson plan 400. In such an example, the student device 110 may be configured to transmit command receipts to the CDS 120 indicating that the student device 110 successfully received an installation command, and the CDS 120 may be configured to perform this operation based on such received command receipts. Other examples are also possible.

In any event, the CDS 120 may determine the second portion of the lesson plan in a number of manners. For instance, the CDS 120 may be configured to perform this operation by referencing the sequence column 402 of the personalized lesson plan 400 and determining the study unit that follows the current study unit 408. For example, the CDS 120 may determine that the second portion of the lesson plan should be or include study unit 410.

Additionally or alternatively, the CDS 120 may be configured to determine the second portion of the lesson plan based on the progress data received in the activity data. For instance, if the progress data indicates that Annie is progressing through her lesson plan at an above average pace (or at least quicker than expected) and/or with an above average comprehension, then the CDS 120 may determine that the second portion of the lesson plan should be or include a study unit that is different from study unit 410. On the other hand, if the progress data indicates that Annie is struggling with the material (e.g., a below average pace and/or scores), the CDS 120 may determine the second portion of the lesson plan should include some of the activities and/or educational content from the first portion of the lesson, activities and/or content similar to those of the first portion of the lesson, and/or aspects of study unit 410. Other examples are also possible. In this way, the CDS 120 may be configured to update the original lesson plan based on Annie's progression through the first portion of the lesson plan.

After the CDS 120 determines the second portion of the lesson plan, the CDS 120 may be configured to determine the educational content, if any, that the student device 110 will need to download in order to allow Annie to work through the second portion of the lesson plan. This determination may involve the CDS 120 utilizing the device identifier received in the activity data. In particular, the CDS 120 may be configured to locate the device profile of the student device 110 using the received device identifier and determine the educational content currently installed on the student device 110. In the example where the second portion of the lesson plan is study unit 410, the CDS 120 may determine that the educational content currently installed on the student device 110 includes the CDS Application and Applications A, B, and C, and so Applications D, E, and F need to be downloaded.

Thereafter, the CDS 120 may be configured to transmit 507 an indication of the second portion of the personalized lesson plan to the student device 110. Generally, the indication of the second portion of the personalized lesson plan may include any information required by the CDS application to assemble the second portion of the personalized lesson plan. An example of this indication may include the sequence information associated with activities from study unit 410, activity instructions for the activities in study unit 410, removal commands for Applications B and C, and installation commands for Applications D, E, and F. In this example, the indication does not include a removal command for Application A because that application is needed for playback of Video 2.

In some examples, the CDS 120 may be configured to generate, and then include in the indication of the second portion of the personalized lesson plan, removal commands based on the number of available content licenses, among other considerations. For instance, if the CDS 120 determines that the number of available content licenses is above a predetermined threshold number, then the CDS 120 may forgo generating removal commands. On the other hand, if the CDS 120 determines that the number of available content licenses is at or below the predetermined threshold number, then the CDS 120 may generate the removal commands. Accordingly, continuing off the above example, in some cases Application A may also be removed and/or one or both of Applications B and C may remain installed on the student device 110.

In any event, the student device 110 may be configured to receive the indication of the second portion of the personalized lesson plan 400 and then automatically use the CDS application to assemble the second portion of the lesson plan. As part of this process, similar to the process for assembling the first portion of the lesson plan, the student device 110 may be configured to utilize the received network locators to download 508 educational content (e.g., Applications D, E, and F) from one or more of the content providers 130.

Additionally, the student device 110 may be configured to remove previously installed educational content, such as Applications B and C, in accordance with the received removal commands. In some cases, this operation may involve the student device 110 un-installing the educational content and then transmitting un-install data to the CDS 120 and/or third-party content provider 130. By doing so, the student device 110 frees up content licenses that were being used by these two installed applications, which may allow the student device 110 and/or other student devices to utilize those content licenses.

In some instances, the student device 110 may be configured to determine that it does not have the educational content that is called for by Annie's personalized lesson plan. For example, Annie may progress through her personalized lesson plan quicker than expected, and Annie may finish with all the educational content stored on the student device 110 before the CDS 120 and/or content providers 130 provide additional educational content to the student device 110.

Similarly, the student device 110 may be additionally or alternatively configured to determine that it failed to receive educational content called for by Annie's personalized lesson plan. That is, the student device 110 may determine that, despite transmitting the request for a given educational content, the student device 110 has yet to receive the given educational content, which could have been a result of network connection problem or some other reason. This determination may involve the student device 110 determining that a predetermined threshold amount of time has elapsed since the student device 110 transmitted the request for educational content.

In such instances, the student device 110 may be configured to perform a number of operations that aim to help continue Annie's personalized learning experience. For example, the student device 110 may be configured to re-initiate downloading missing educational content. In another example, the student device 110 may be configured to additionally or alternatively transmit an alert message to a teacher or staff device. In yet another example, the student device 110 may be additionally or alternatively configured to replace the missing educational content with locally stored educational content or content that is otherwise currently available to the student device 110, such as content available through websites and the like. For instance, the student device 110 may be configured to determine educational content, activities, or specific problems that Annie has yet to complete and incorporate that material into her personalized lesson plan until additional content is available. In some cases, the student device 110 may be configured to determine activities or specific problems that Annie has struggled with or answered incorrectly and incorporate that material into her personalized lesson plan.

In other examples, the student device 110 may be additionally or alternatively configured to replace the missing educational content with “backup” educational content that otherwise is not used in the lesson plan. In particular, in such examples, the CDS 120 may be configured to include backup educational content in a given indication of a portion of a lesson plan, such as the indication of the first portion of the lesson plan. The CDS 120 may include backup educational content when the student device 110 does not have a predetermined amount of backup content. In any event, the student device 110 may then be configured to install the backup educational content and utilize it if the student device 110 determines that the student device 110 does not have content called for by the personalized lesson plan. After Annie completes the backup educational content, the student device 110 may be configured to send to the CDS 120 a backup request for new backup educational content.

In some examples, the student device 110 may be additionally or alternatively configured to skip the missing educational content altogether and perhaps move on to other educational content, such as a post-quiz. In some cases, the student device 110 may be configured to do so if the completed activities exceed a threshold, such as a threshold percentage complete or threshold score. Other examples are also possible.

In some cases, the CDS 120 may be configured to facilitate obtaining missing educational content. For example, the student device 110 may be configured to provide installation data to the CDS 120 indicating one or more educational content that have been installed by the student device 110. The student device 110 may do so periodically or each time that the student device has installed educational content.

Based on the received installation data and a transmitted indication of a portion of the lesson plan (e.g., the indication of the first portion of the lesson plan), the CDS 120 may be configured to determine educational content that the student device 110 has yet to install. For example, the CDS 120 may be configured to compare the installed educational content indicated by the received installation data with the educational content that the CDS 120 instructed the student device 110 to download via installation commands provided in the indication of the first (or second) portion of the lesson plan.

If the CDS 120 determines that the student device 110 has yet to install one or more educational content that it should have installed, the CDS 120 may be configured to transmit to the student device 110 installation commands for the student device to install the one or more educational content. In this way, the CDS 120 instructs the student device 110 to re-attempt the download.

In practice, some of the above-discussed operations may be repeated as Annie continues using her student device 110 to progress through her personalized lesson plan 400 and/or when Annie wishes to start a new personalized lesson plan. In practice, some or all of the above-discussed operations may also be performed when another student wishes to utilize the student device 110 once Annie is finished for the day.

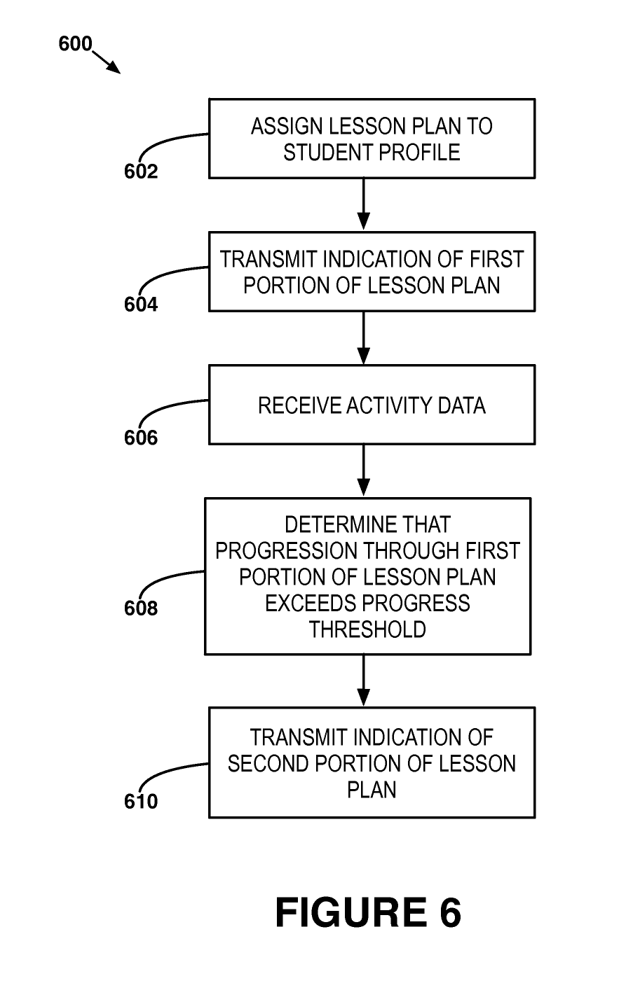

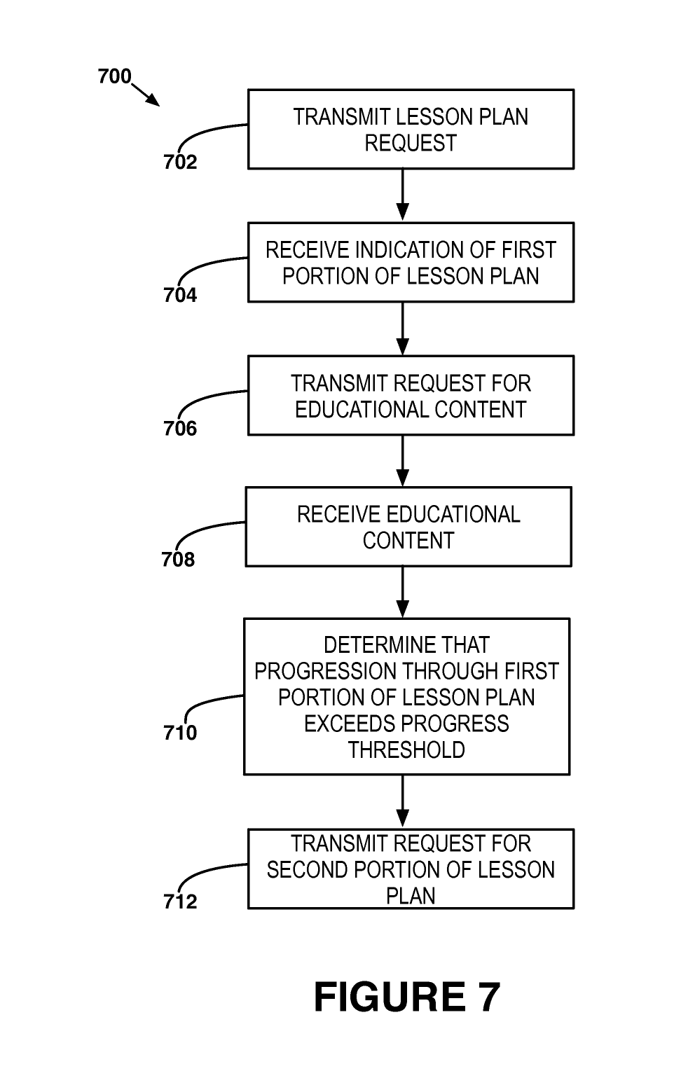

In examples, a computing device or system may perform a combination of some of the operations described above to carry out an example method. For instance, FIG. 6 illustrates an example method 600 that may be carried out by a computing system, such as the CDS 120, and FIG. 7 illustrates an example method 700 that may be carried out by a computing device, such as the student device 110. In some implementations, the CDS 120 and student device 110 may concurrently perform methods 600 and 700, respectively.

For the methods illustrated and disclosed herein, the flow diagrams show functionality and operations of one possible implementation. Although the blocks are illustrated in sequential order, these blocks may be performed in parallel and/or in a different order than those described herein. Also, the various blocks may be combined into fewer blocks, divided into additional blocks, and/or removed and/or additional blocks may be added based upon the desired implementation.

In some examples, each block may represent circuitry that is wired to perform the specific logical functions in the method. In other examples, each block may represent a module, segment, or portion of program code that includes instructions that are executable by a processor to perform specific logical functions or operations in the method. The program code may be stored on any type of computer-readable medium, such as a storage device. The computer-readable medium may include non-transitory computer-readable medium, such any form of volatile or non-volatile storage media. The computer-readable medium may be considered a computer-readable storage medium, for example, or a tangible storage device.

As shown in FIG. 6 at block 602, the method 600 may involve the CDS 120 assigning a lesson plan to a student profile, such as the student profile associated with the student device 110, where the lesson plan includes at least a plurality of educational content. At block 604, the method 600 may involve the CDS 120 transmitting to a computing device, such as the student device 110, an indication of a first portion of the lesson plan. At block 606, the method 600 may involve the CDS 120 receiving from the computing device activity data that includes at least progress data indicating a progression through the first portion of the lesson plan. At block 608, the method 600 may involve the CDS 120, based at least on the progress data, determining that the progression through the first portion of the lesson plan exceeds a progress threshold. At block 610, the method 600 may involve the CDS 120, based at least on determining that the progression exceeds the progress threshold, providing to the computing device an indication of the second portion of the lesson plan.

Turning to FIG. 7, at block 702, the method 700 may involve the student device 110 transmitting to a computing system, such as the CDS 120, a lesson plan request that includes at least a device identifier. At block 704, the method 700 may involve the student device 110 receiving from the computing system an indication of a first portion of a lesson plan, where the indication of the first portion of the lesson plan includes at least a plurality of identifiers of respective educational content. At block 706, the method 700 may involve the student device 110, based on the received indication of the first portion of the lesson plan, transmitting to one or more content servers, such as third-party content providers, a request for educational content, where the request for the educational content includes at least one identifier from the plurality of identifiers. At block 708, the method 700 may involve the student device 110 receiving from the one or more content servers educational content. At block 710, the method 700 may involve the student device 110 determining that a progression through the first portion of the lesson plan exceeds a progress threshold. At block 712, the method 700 may involve the student device 110, based on the progression exceeding the progress threshold, transmitting to the computing system a request for a second portion of the lesson plan.

Although the above operations were discussed in relation to interactions between Annie's student device 110 and the CDS 120 and/or content providers 130, one of ordinary skill in the art will appreciate that the same or similar operations may occur concurrently with multiple other student devices. Indeed, in examples, the CDS 120 may be configured to make lesson plan determinations and/or to perform other operations based on classroom-, school-, or district-wide considerations.

For example, the CDS 120 may be configured to predict a school district's educational content needs, and thus required number of content licenses, for a particular period of time. That is, the CDS 120 may be configured to predict what content and how much of that content a school district may require over a period of time. Based on such predictions, the CDS 120 may be configured to intelligently and automatically purchase or otherwise acquire content licenses on behalf the school district, perhaps taking advantage of bulk purchase or other discounts. Thereafter, the CDS 120 may assign content licenses to student accounts or student devices, and students can then receive personalized educational content as described above.

Broadly speaking, the CDS 120 may be configured to make such predictions at a student level. For example, the CDS 120 may be configured to predict the needs of each student within the school district and use such predictions to make a district-wide prediction. As such, the CDS 120 may be configured to utilize historical, simulated, and/or current data to make such predictions. The CDS 120 may be configured to store or communicate with another system that provides such data.

As for historical data, the CDS 120 may be configured to make predictions based on past license purchases by the school district, past student enrollment numbers for the school district, and/or past student assessment and/or progress data corresponding to students within the school district, among other considerations. Additionally or alternatively, the CDS 120 may be configured to utilize similar information from other school districts. Current data may include some or all of the same types of data as the historical data.

With respect to simulated data, the CDS 120 (or a service provider) may be configured to simulate district-wide license usage. In particular, the CDS 120 may be configured to simulate how students may progress through personalized lesson plans, thereby determining what content is likely to be required and thus how many licenses that should be purchased.

In practice, the CDS 120 may be configured to determine an expected number of content licenses projected to be used within a predetermined duration of time. For instance, the CDS 120 may be configured to determine an initial license-purchase prediction that indicates a predicted number of content licenses that a given school district may require for a predetermined period of time. In examples, the predetermined duration of time may be a number of weeks, a number of months, a first half of a school year, or some other amount of time. For purposes of example and explanation only, the below discussion assumes an exemplary predetermined duration of time of four weeks.

In practice, determining the initial-license purchase prediction may involve identifying the students that are enrolled at a school within the school district for a given school year. This operation may involve the CDS 120 receiving or identifying a previously received student roster for each school within the school district. Generally, a student roster may indicate student identifiers of each student enrolled to attend a school within the school district for a given school year. Such a roster may be uploaded to the CDS 120 via a school-district computing device or a service provider the school district utilizes, among other examples.

Thereafter, the CDS 120 may be configured to determine initial needs of each identified student. This operation may involve the CDS 120 accessing the student profiles for each identified student in the student profile database 312. Then, for each student profile, the CDS 120 may access any personalized lesson plans for the given student and analyze the educational content that is called for by the personalized lesson plans.

The CDS 120 may be configured to project each student's respective progress through the personalized lesson plans over the first four weeks of the school year. This operation may involve the CDS 120 evaluating several considerations, such as a given student's assessment data, historical or simulated progress data for the educational content called for in the given student's personalized lesson plans, and/or historical progress data of the given student in prior school years, among other considerations. From this projection, the CDS 120 may then determine the educational content that the given student is expected to need in the first four weeks of the school year.

The CDS 120 may be configured to attribute certain weights to the determined educational content based on the status of the activity associated with the educational content. For instance, educational content that is associated with an activity that is “fixed” (e.g., one that a student is required to perform, such as Videos 1 and 2 and Activity 3 from FIG. 4) may be attributed a first weight, such as a “1”, while educational content associated with an activity that is “optional” (e.g., one that the student may or may not perform based on his or her discretion, such Activities 1, 2, 4, and 5 from FIG. 4) may be attributed a second weight, such as a “½”. Other example weights are also possible. In practice, the particular weights may be predetermined when a lesson plan is created or determined based on historical student data, among other possibilities. In any event, the CDS 120 may be configured to sum the various weights attributed to each of the determined educational content.

Additionally, the CDS 120 may be configured to determine a per-device factor that may reduce the weight attributed to the educational content. This operation may involve the CDS 120 analyzing a number of considerations, such as the number of students enrolled in the school district, the number of student devices owned by the school district, and/or the school district's student-device implementation model, to determine a maximum number of student devices that the educational content needs to be on at any given time.

A student-device implementation model indicates how students utilize student devices in a given school district. In particular, the student-device implementation model may indicate the number of students assigned to a given student device. For example, a student-device implementation model where each student is assigned his or her own student device may have a per-device factor of “1”, while an implementation model where two students share a student device and those two students are projected to need the same educational content around the same time may have a per-device factor of “½”. The CDS 120 may be configured to attribute the per-device factor to the weight attributed to the corresponding educational content. For example, the CDS 120 may multiply the weight by the per-device factor.

Alternatively, a per-device factor may affect the weight in other manners. For example, Student A and Student B may share Student Device 1, Student C and Student D may share Student Device 2, and Students A, B, and D may each need Video Z for their respective personalized lesson plans. The CDS 120 may be configured to determine that two content licenses for educational content Video Z are needed as opposed to three licenses (based on a per-student basis) or 1.5 licenses (based on the CDS 120 being configured as the previous example). The CDS 120 may be configured to utilize per-device factors in other manners as well.

The CDS 120 may be configured to then determine a weighted total for each student and from that, determine a total for the whole school district. In examples, the CDS 120 may be configured to round up any fractional totals, while in other examples the CDS 120 may round down. Additionally or alternatively, the CDS 120 may be configured to add a predetermined prediction buffer, such as a percentage of the determined total (e.g., 20%), to the total for the whole school district.

In any event, the CDS 120 may be configured to purchase or otherwise acquire a number of content licenses equal to the determined school-district total. In some examples, before purchasing the licenses, the CDS 120 may be configured to further modify the total or perhaps perform a wholly new initial prediction (e.g., that projects for more or less than the first four weeks of the school year) based on considerations such as a yearly budget, a remaining budget, a maximum at-one-time spending amount, costs of educational content, bulk discounts, and/or any temporary discounts, among other considerations.

Thereafter, the CDS 120 may be configured to assign the purchased content licenses to student accounts or student devices and transmit respective installation commands to the student devices, thereby allowing student devices to obtain educational content for personalized lesson plans. As such, a given installation command may indicate a command for a given student device to utilize a given content license to obtain educational content from a given content provider 130, where the given content license is one from the purchased content licenses. Moreover, the CDS 120 may also transmit to another computing system (e.g., a content provider 130, such as Apple's iTunes® store) assignment information that indicates particular licenses that have been assigned to a given student device or student account.

As discussed above, as students progress through their respective personalized lesson plans, the student devices may be configured to transmit activity data to the CDS 120. The CDS 120 may in turn be configured to receive from multiple student devices activity data that includes at least respective progress data.

At some point in time, based at least in part on received progress data, the CDS 120 may be configured to determine another license-purchase prediction that indicates a predicted number of content licenses that the school district may require for the ensuing four weeks. In practice, the CDS 120 may be configured to perform this operation in response to a number of triggers. For example, the CDS 120 may be configured to determine license-purchase predictions periodically, perhaps at the end of each school week or after some other threshold amount of time. In other examples, the CDS 120 may perform this operation based on a determination that the number of remaining available (e.g., unassigned) content licenses is below a predetermined threshold. Other triggers are also possible.

In any event, the CDS 120 may be configured to determine this license-purchase prediction in a similar manner as it determined the initial-license purchase prediction as discussed above. However, to determine the needs of each student, the CDS 120 may be configured to additionally or alternatively utilize received progress data for the corresponding student. For instance, the CDS 120 may be configured to project a given student's progress through his or her personalized lesson plans over the next four weeks of the school year based on the given student's current pace and performance indictors, among other considerations. Moreover, the CDS 120 may be configured to account for any changes to lesson plans and/or curriculum goals.

Further, the CDS 120 may be configured to determine the degree at which the student devices are currently reusing content licenses. For example, as discussed above, the CDS 120 may receive un-install data from the student devices, and from that information, the CDS 120 may determine a district-wide reuse efficiency. From this determination, the CDS 120 may determine a reuse scale factor that may modify the school-district total for the current license-purchase prediction. As such, the CDS 120 may be configured to dynamically determine a reuse scale factor. In other examples, the CDS 120 may instead be configured to utilize a predetermined reuse scale factor (e.g., one that was predetermined based on reuse information from one or more previous years). Other examples are also possible.

After the CDS 120 determines the school-district total, the CDS 120 may be configured to subtract the number of purchased licenses that are currently available, and/or perhaps that may become available within a given time period, from the school-district total and then purchase or otherwise acquire the resulting number of content licenses. Then, the CDS 120 may be configured to assign purchased content licenses to student accounts or student devices, thereby allowing student devices to obtain educational content for personalized lesson plans, as discussed above.

In some examples, the CDS 120 may be configured to modify a given license-purchase prediction based on a previously determined full academic-year prediction. For instance, the CDS 120 may perform a full academic-year prediction before or at the start of a given school year in line with the above discussion. Such a prediction may provide an approximate estimate of the total number of licenses a school district may require for educational content for the full academic-year. The CDS 120 may be configured to compare the given license-purchase prediction for a given four week period of time to the previously determined full academic-year prediction. For example, if the given license-purchase prediction results in a school-district total that is less than a number of licenses required to be purchased to obtain a bulk discount and the full academic-year prediction total is equal to or greater than the bulk-discount number of licenses, then the CDS 120 may be configured to modify the license-purchase prediction (e.g., increase the school-district total) to take advantage of the bulk discount.

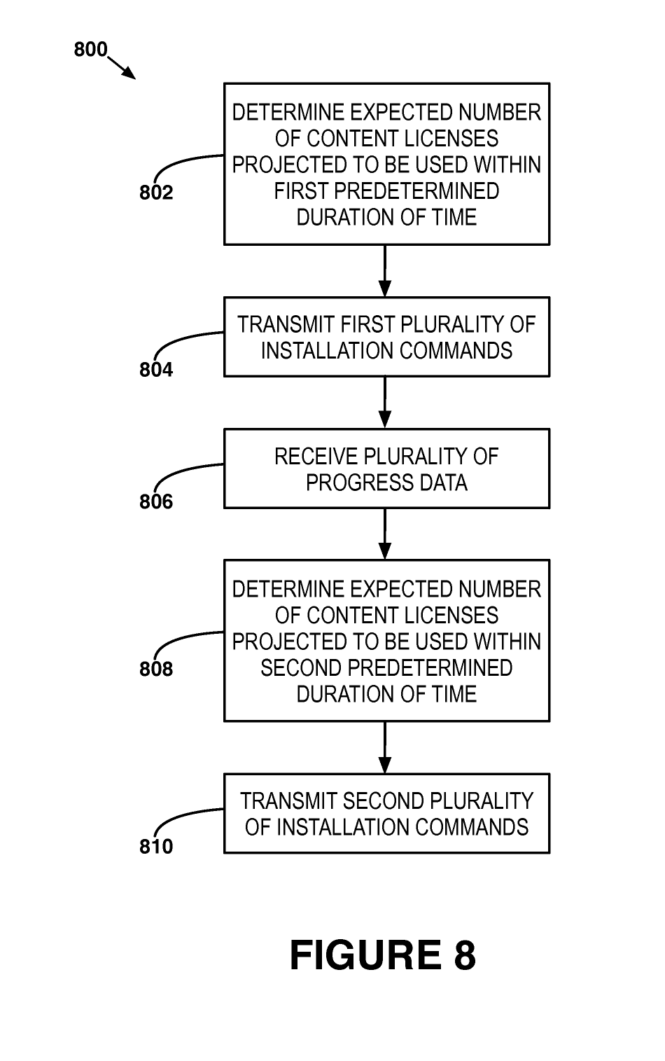

One of ordinary skill in the art will appreciate that the above-discussed operations may be automatically repeated throughout the school year, thereby allowing school-district administrators to focus on other matters and continuously saving the school district money. For example, FIG. 8 shows a flow diagram that illustrates example operations that may be carried out by the CDS 120, perhaps several times over the course of school year, in accordance with example method 800.

As shown in FIG. 8, at block 802, method 800 may involve the CDS 120 determining an expected number of content licenses projected to be used within a first predetermined duration of time. For example, the CDS 120 may determine a projected number of content licenses that student devices within a given school district may utilize within a given four-week period of time. Based on the determined expected number of content licenses, the CDS 120 may purchase a number of content licenses equivalent to the determined expected number of content licenses.

At block 804, the method 800 may involve the CDS 120 transmitting to a plurality of student devices a plurality of installation commands, where a given installation command indicates a command for a given student device to utilize a given content license to obtain educational content from a given third-party content provider. The given content license may be from the purchased content licenses. In examples, the CDS 120 may perform this operation in connection with transmitting an indication of a portion of a lesson plan, as discussed above.

At block 806, the method 800 may involve the CDS 120 receiving from the plurality of student devices a plurality of progress data. In practice, this operation may be performed in a manner similar to the above-discussion with respect to the CDS 120 receiving progress data from Annie's student device 110. However, here, the CDS 120 receives progress data from multiple student devices indicating multiple students' respective progressions through their personalized lesson plans.

At block 808, the method 800 may involve the CDS 120, based at least on the received progress data, determining an expected number of content licenses projected to be used within a second predetermined duration of time. The second predetermined duration of time may have the same or a different duration than the first predetermined duration of time. As an example, the CDS 120 may project a number of content licenses that student devices within the given school district may utilize within a one-week period after the first four-week period of time.

At block 810, the method 800 may involve the CDS 120 transmitting to the plurality of student devices a second plurality of installation commands. In practice, this operation may be performed in a similar manner as in block 804. It should be understood that additional operations, such as any described herein, may be performed along with those described in relation to method 800.

Although the above prediction operations were discussed at a district-wide level, one of ordinary skill in the art will appreciate that the same or similar operations may be utilized at a school- or classroom-wide level. That is, operations discussed above may be implemented to predict the educational content needs, and thus required number of content licenses, for a particular school or even particular classroom, among other possibilities.

At times, the above discussion refers to a “school”, “school district”, or “classroom.” One of ordinary skill in the art will appreciate that the operations described herein may readily be implemented in other contexts to help serve other educational purchasing entities, such as home school networks, international educational systems, charter organizations, a group of classrooms, and other educational organizations. As such, these terms as well as other terms used above should not be construed as limiting.

While some examples described herein may refer to operations performed by given actors, such as “users”, “students”, “teachers”, and/or other entities, this description is for the purposes of example and explanation only. Accordingly, the claims should not be construed to require action by such actors unless the claim language itself explicitly recites such actors performing the actions.

### VI. Conclusion

The description above discloses, among other things, various example systems and device that include, among other components, software executed on hardware. It should be understood that such examples are merely illustrative and should not be considered as limiting. For example, it is contemplated that any or all of the hardware and/or software aspects may be embodied exclusively in hardware, exclusively in software, or in any combination of hardware and/or software. Accordingly, the systems, devices, and methods described above may be implemented differently than the above discussion.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

When any of the below claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

We claim:

1. A computing system comprising:
a network interface;
at least one processor;
a non-transitory computer-readable medium; and
program instructions stored on the non-transitory computer-readable medium that are executable by the at least one processor to cause the computing system to:
transmit to a computing device an indication of a first portion of a lesson plan, wherein the lesson plan comprises a plurality of educational content;
receive from the computing device via the network interface activity data comprising progress data indicating a progression through the first portion of the lesson plan;
based at least on the progress data, determine that the progression through the first portion of the lesson plan exceeds a progress threshold; and
based at least on determining that the progression exceeds the progress threshold, transmit to the computing device an indication of a second portion of the lesson plan.

2. The computing system of claim 1, wherein the indication of the first portion of the lesson plan comprises a first installation command and a second installation command, wherein the first installation command indicates a command for the computing device to install first educational content from a first third-party content provider, and wherein the second installation command indicates a command for the computing device to install second educational content from a second third-party content provider.

3. The computing system of claim 1, wherein the indication of the second portion of the lesson plan comprises an installation command indicating a command for the computing device to install educational content from a third-party content provider.

4. The computing system of claim 3, wherein the installation command is a second installation command indicating a command for the computing device to install second educational content from a second third-party content provider, wherein the indication of the first portion of the lesson plan comprises a first installation command indicating a command for the computing device to install first educational content from a first third-party content provider, and wherein the indication of the second portion of the lesson plan further comprises a removal command indicating a command for the computing device to remove the first educational content.

5. The computing system of claim 1, wherein the program instructions further comprise program instructions that are executable by the at least one processor to cause the computing system to:
after transmitting the indication of the first portion of the lesson plan, receive from the computing device installation data indicating one or more educational content that have been installed by the computing device;
based on the received installation data and the transmitted indication of the first portion of the lesson plan, determine a first educational content that the computing device has yet to install; and
transmit to the computing device an installation command indicating a command for the computing device to install the first educational content from a third-party content provider.

6. The computing system of claim 1, wherein the progression data comprises an indication of a pace of the progression through the first portion of the lesson plan, and wherein the progress threshold comprises an expected pace of progression through the first portion of the lesson plan.

7. The computing system of claim 1, wherein the progression data comprises a performance indicator indicating a score associated with the progression through the first portion of the lesson plan, and wherein the progress threshold comprises a score value indicating a passing score on the first portion of the lesson plan.

8. The computing system of claim 1, wherein the progress threshold is a first progress threshold, and wherein the program instructions further comprise program instructions that are executable by the at least one processor to cause the computing system to:
based at least on the progress data, determine that the progression through the first portion of the lesson plan is below a second progress threshold;
based on determining that the progression is below the second progress threshold, update the lesson plan; and
transmit to the computing device an indication of a portion of the updated lesson plan.

9. The computing system of claim 1, wherein the progress threshold is a first progress threshold, and wherein the program instructions further comprise program instructions that are executable by the at least one processor to cause the computing system to:
based at least on the progress data, determine that the progression through the first portion of the lesson plan is below a second progress threshold; and
based on determining that the progression through the first portion of lesson plan is below the second progress threshold, transmit to the computing device a removal command indicating a command for the computing device to remove at least one educational content corresponding to the first portion of the lesson plan.

10. The computing system of claim 1, wherein the activity data further comprises a device identifier corresponding to the computing device, and wherein the program instructions further comprise program instructions that are executable by the at least one processor to cause the computing system to:
based on the device identifier, determine educational content currently installed on the computing device.

11. The computing system of claim 10, wherein the indication of the second portion of the lesson plan comprises installation commands indicating commands for the computing device to install one or more educational content, and wherein the program instructions further comprise program instructions that are executable by the at least one processor to cause the computing system to:
based at least on the progress data and the determined educational content currently installed on the computing device, determine the one or more educational content to be installed by the computing device.

12. The computing system of claim 1, wherein the program instructions further comprise program instructions that are executable by the at least one processor to cause the computing system to:
after transmitting to the indication of the first portion of a lesson plan, receiving from the computing device installation data indicating one or more educational content that have been installed by the computing device;
based on the installation data, determining an installation state of the computing device; and
based on the installation state of the computing device, transmit to the computing device the indication of the second portion of the lesson plan.

13. A computing device comprising:
a network interface;
at least one processor;
a non-transitory computer-readable medium; and
program instructions stored on the non-transitory computer-readable medium that are executable by the at least one processor to cause the computing device to:
receive from a computing system via the network interface an indication of a first portion of a lesson plan, wherein the indication of the first portion of the lesson plan comprises a plurality of identifiers of respective educational content;
based on the received indication of the first portion of the lesson plan, transmit to one or more third-party content providers a request for educational content, wherein the request for educational content comprises at least one identifier from the plurality of identifiers; and
receive from the one or more third-party content providers educational content identified by the at least one identifier.

14. The computing device of claim 13, wherein the plurality of identifiers comprises a first identifier of first educational content and a second identifier of second educational content, and wherein transmitting to the one or more third-party content providers the request for educational content comprises transmitting to a first third-party content provider a request for the first and second educational content, wherein the request for the first and second educational content comprises the first and second identifiers.

15. The computing device of claim 13, wherein receiving from the one or more third-party content providers the educational content identified by the at least one identifier comprises (1) receiving from a second third-party content provider the first educational content and (2) receiving from a third third-party content provider the second educational content.

16. The computing device of claim 13, wherein the plurality of identifiers comprises a first identifier of first educational content and a second identifier of second educational content, and wherein transmitting to the one or more third-party content providers the request for educational content comprises (1) transmitting to a first third-party content provider a request for the first educational content, wherein the request for the first educational content comprises the first identifier, and (2) transmitting to a second third-party content provider a request for the second educational content, wherein the request for the second educational content comprises the second identifier.

17. The computing device of claim 13, wherein the program instructions further comprise program instructions that are executable by the at least one processor to cause the computing device to:
receive input data indicating a progression through the received educational content; and
based on the progress data, determine a progression through the first portion of the lesson plan.

18. The computing device of claim 17, wherein the program instructions further comprise program instructions that are executable by the at least one processor to cause the computing device to:
determine that the progression through the first portion of the lesson plan exceeds a progress threshold; and
based on the progression exceeding the progress threshold, transmit to the computing system a request for a second portion of the lesson plan.

19. The computing device of claim 13, wherein the program instructions further comprise program instructions that are executable by the at least one processor to cause the computing device to:
determine that the computing device failed to receive at least one educational content identified by the at least one identifier; and
based on determining that the computing device failed to receive the at least one educational content, replace the at least one educational content with one of a locally stored educational content.

20. A method comprising:
a computing system assigning a lesson plan to a student profile, wherein the lesson plan comprises a plurality of educational content;
the computing system transmitting to a computing device corresponding to the student profile an indication of a first portion of a lesson plan, wherein the indication of the first portion of the lesson plan comprises at least one installation command indicating a command for the computing device to install educational content from a third-party content provider;
the computing system receiving from the computing device via the network interface activity data comprising progress data indicating a progression through the first portion of the lesson plan;
the computing system, based at least on the progress data, determining that the progression through the first portion of the lesson plan exceeds a progress threshold; and
the computing system, based at least on determining that the progression exceeds the progress threshold, transmitting to the computing device an indication of a second portion of the lesson plan.
